(19) United States
(12) Patent Application Publication
(10) Pub. No.: US 2005/0165719 A1
(43) Pub. Date: Jul. 28, 2005

(54) Method and system for establishing and maintaining concurrent, coordinated communications on separately managed networks

(75) Inventors: Steven L. Greenspan, Scotch Plains, NJ (US); Evan Crandall, Basking Ridge, NJ (US); Nancy Mintz, Summit, NJ (US); David Mark Weimer, Aberdeen, NJ (US)

Correspondence Address: David M. Weimer, 16 Imbrook Lane, Matawan, NJ, 07747-1508, US

(73) Assignee: Omenti Research, LLC

(21) Appl. No.: 10/764,874

(22) Filed: Jan. 27, 2004

(51) Int. Cl. G06F 7/00

(52) U.S. Cl. 707/1

(57) ABSTRACT

An improved method for sharing multimedia information across a data communication network based on a concurrent connection among users communicating with one another on a first communication network such as a telephone network, the data communication network distinct from the first communication network. Attributes of the first communication network (e.g., phone call or conference call) are used to establish a means of transmitting information over the data communication network (e.g., a cable network) to the same users who are communicating with one another over the first communication link. When the first communication link is established, a session identifier is created and associated with the user accounts of two or more participants. The user account data are used to specify which users of a second communication link are granted permission to join the specified data communication session. When a user of the first communication network accesses the data communication network, the user is notified and can join the specified session.

### FEDERALLY SPONSORED RESEARCH

Not Applicable

### SEQUENCE LISTING OR PROGRAM

Not Applicable

### BACKGROUND

1. Field of Invention

The present invention relates to systems and methods for establishing concurrent communication on multiple, separately managed networks, and more particularly to information systems that allow participants to share multimedia information in real-time.

2. Background

The number of methods for communicating has increased dramatically during the last quarter of the 20th century. Various networks have emerged such as the Global Switched Telephone Network for wired and wireless telephones (and facsimile machines), the Internet for routing packetized data from one computer to another, and the Direct Broadcast System for broadcasting television systems. Each of these networks have been optimized for the devices that they interconnect, however, they are not typically designed to work with one another (although they may transport signals meant for another network as when a telephone is used with a dial up modem.) Moreover, the networks are generally optimized for one type of communication: for example, the Telephone Network is optimized for voice communication, DBS for audio-video broadcasts. Interoperability between these networks is poor; connectivity on one network does not typically invoke services on another network (exceptions are provided in U.S. Patents [U.S. Pat. No. 5,838,682], [U.S. Pat. No. 6,259,774], and [U.S. Pat. No. 6,425,131]). For example, in order to share visuals on a data network, audio conference participants will independently create a separate multimedia communication session on a data communication network. More often than not, participants send email to one other, hoping that the others' email applications will quickly receive the transmission, or dictate strings corresponding to URLs (Uniform Resource Locator). These methods can waste valuable time and create confusion. Moreover, independently establishing these connections restricts the types of service features that can be offered.

Accordingly, it would be useful to establish a conference call using the telephone network and to automatically enable participants to use nearby display devices (e.g., televisions, hand held computers, laptop computers, and desktop computers) to exchange visual information.

One method of linking a telephone call with web co-browsing, in which the called party can redirect the caller's web browser, was disclosed by Dekelbaum et al. (U.S. Pat. No. 5,838,682). Dekelbaum teaches a method whereby selecting an html hyperlink in a standard web browser on a standard PC instructs the PC to originate a call to a call center. The hyperlink also redirects the web browser to another URL and creates a web session id. The information specified in the hyperlink or in the fulfillment of the URL request, is used by the call center to associate the web session id with the incoming phone call. Alternatively, the information can be transmitted over the phone line when the call is first connected to the call center. These methods have a number of limitations, among which are:
(a) The call needs to originate from the PC that controls the web browser. Functionally this means that call centers can receive these types of calls, but not originate them.
(b) The web browser must be pointing to the appropriate URL to initiate the communication method. This means that to coordinate a web session and a phone call, the web session must be created before a phone call is originated.
(c) The web session is associated with a single incoming telephone call. This means that the method cannot obviously handle three or more parties (conference calls).
(d) Special software must exist at the call center to coordinate the phone call with the previously established web session.

Miloslavsky (U.S. Pat. No. 6,259,774) extends the art by teaching a new method whereby either (a) the hyperlink is used to signal a call center that a telephone call from a user specified telephone number is about to be received, or (b) a call center is instructed via the hyperlink to call the user (and the user's phone number is entered by the user).

This new set of methods overcome one limitation of Dekelbaum et al., namely the restriction that the call must originate on the customer's PC. Instead, the call can originate on any customer's telephone as long as the call center software has been notified that a call from that telephone number is expected, or the call can be from the call center to the user, as long as the user has specified the to-be-called telephone number.

Crandall et al (U.S. Pat. No. 6,425,131) adopted an entirely different approach to overcome many of the limitations of Dekelbaum et al. This method uses call signaling from an initial telephone calling event (or the public switched network, PSTN) to determine the telephone numbers involved in a POTS call. These phone numbers are used to query a database associating phone numbers with nearby desktop computers. Crandall et al., thus rely on a pre-established database containing an association between a user's telephone number and the network address of a user's nearby display device (e.g., a PC or TV). This method had several advantages over Dekelbaum et al. and Miloslavsky. The method taught by Crandall et al enabled calls to originate from a call center agent or from a customer, and allowed these phone calls to precede any Internet activity between the call center's web server and the customer's PC. In addition, conference calls could be handled by maintaining a list of telephone—network address associations and using them to define a single coordinated, group telephone-web session. Furthermore, the method could work between residential users, and not just between a call center and a customer. Finally, other devices could be used as long as they had a unique network address and had been previously associated with the user's telephone number.

However, the Crandall et al. method suffers from several limitations:
(a) Phone calls must precede the Internet-based portions of the communication sessions, and
(b) The network addresses had to be known in advance and therefore each device has a fixed network address. However, devices are often linked to the Internet using dynamically generated network addresses. This is typical with wireless hand held computers that connect to the Internet through 802.11b networks. It is often the case, when cable or DSL modems and TV set top boxes are attached to their respective networks.

The use of fixed network addresses creates barriers to implementing services that allow people to use different devices from different places. It requires the knowledge of the exact address of devices that are to be contacted, either by the user or by a service database/registry. Maintaining accurate data is difficult to guarantee, and imposes a burden on the users. Whenever a new device is to be used that is not already associated with the telephone number or email address, the new device address would need to be entered into the registry before it could be reached by other parties.

### OBJECTS AND ADVANTAGES

The invention covered in this disclosure uses a novel and more flexible method of coordinating phone calls with visual displays (not just HTML pages). It allows use of telephone numbers, email addresses, or other unique identifiers to set up a visual communications channel to another party's PC, TV, or mobile device. It also allows multiple display device types (e.g., PCs, TVs, PDAs) to participate in a group (or multi-way) session, as well as multiple voice networks (e.g., PSTN and voice-over-Internet). Furthermore, during group sessions, it allows users to participate without a telephone or by using a telephone connected to a different set of speakers who are using the same synchronized visual presentation (as might be needed if a class were to provide voice translation for non-native speakers). Conversely, it allows a single voice conference to be associated with multiple, synchronized presentations (thus accommodating different display devices and bandwidth limits.) Unlike many teleconference/groupware applications (e.g., those provided by Webex), this new method does not require users to initiate the teleconference through a website. The coordinated session can begin with a phone call or software on the PC with a web session, and any user can initiate the phone call or web session.

The new invention allows the setup of the parallel visual channel after an initial POTS call with a new method that overcomes limitations imposed by mapping one device address directly with another device address. This invention can use a telephone number or any address that identifies a unique household or an address that identifies an individual (e.g. email address, IM handle). This invention also includes methods of setting up connections to a messaging system that acts as a visual answering machine, storage for recording visuals during visually augmented telephone calls, and methods of using the stored visuals to enhance other telephone calls in the future.

### SUMMARY

The invention allows the coordination of two communication pathways even if the pathways are on separately managed networks. More precisely, the invention provides an improved method for using the attributes of a first communication link (e.g., phone call or conference call) to establish a means of transmitting information over a second communication link (e.g., a cable network) to the participants of the first communication link.

As an exemplary illustration, the invention uses a phone call (or conference call) to establish an ability to send visuals from one participant to another, where some of the participants maybe viewing the visuals on PCs or Cable televisions.

The invention also establishes, within the context of coordinated channels for voice and multimedia communication, methods for transmitting any mime type across the multimedia channel, and new presentation methods for supporting group or one-on-one presentations. Any mime type, e.g., a visual image, can be encapsulated in a ftp message to a network server and can be associated with a URL and the sender application can request that a receiving application (e.g., a web browser) retrieve the data at the associated URL. Timers and other software applications can monitor a presentation and can archive it so that annotations, sequence, and timing information can be used to control subsequent playback of the presentation.

### DRAWINGS

Drawing Figures

FIG. 1 illustrates an exemplary system of the present invention.

FIG. 2 illustrates another exemplary system of the present invention.

FIGS. 3A, 3B and 3C illustrates an exemplary method of the present invention, where FIGS. 3A and 3B represent steps which may occur in parallel or in sequence to one another, but prior to those in FIG. 3C.

FIGS. 4A 4B, 4C and 4D provide detailed illustrations of exemplary methods for identifying users and specifying which users can share data with one another.

FIGS. 5a and 5b provides an exemplary illustration of the user account record before (FIG. 5A) and after (FIG. 5B) a session identifier has been associated with a user account.

FIGS. 6a and 6b provides an exemplary illustration of the session management records before (FIG. 6A) and after (FIG. 6B) a data sharing connection has been established with one or more user accounts.

### DETAILED DESCRIPTION

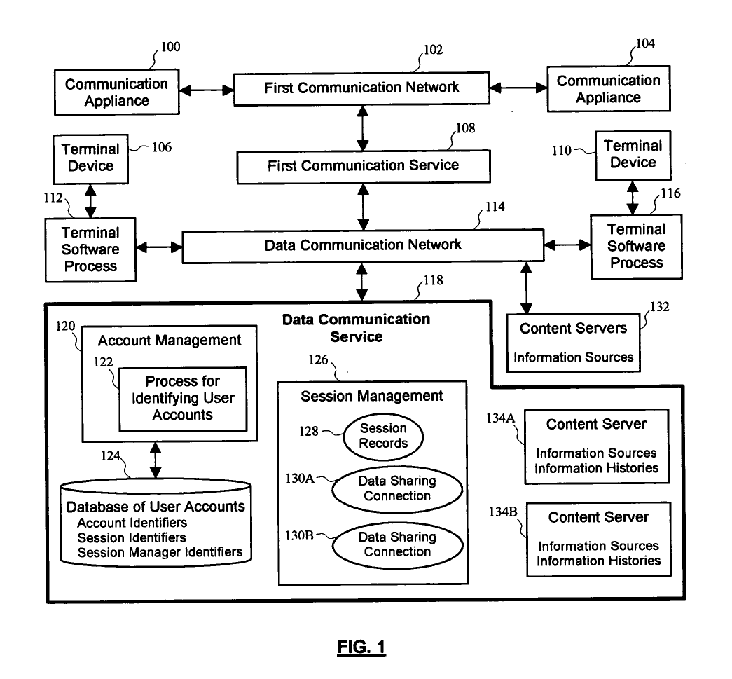

FIG. 1 is a block diagram of an exemplary embodiment of the present invention. For example, two people are talking with one another using telephones connected through the public switched network to a teleconference bridge; they wish to simultaneously share visual documents with one another over the Internet, using nearby PCs. Referring to FIG. 1, the telephones are illustrated by communication handset 100 and 104, the public switched network is an example of first communication network 102, and the teleconference bridge is an example of first communication service 108. The telephones may be standard wire line phones connected directly to the public switched network, or one or both may be connected to the public switched network through a wireless network, a private branch exchange (PBX), or a packet network. To share visual information, these people log into data communication service 118. They do this by using nearby PCs each containing, among other elements, a terminal device for input and output and a terminal software process for managing communications with data communication service 118 via the Internet. A PC monitor, mouse and keyboard together comprise an example of a terminal device, and therefore illustrate an example of terminal devices 106 and 110. Software executing on a PC central processor may embody terminal software processes 112 and 116 and the Internet is the preferred example of data communication network 114. Alternative examples of terminals devices 106 and 110 are TV monitors working in association with interactive TV apparatus that execute terminal softer processes 112 and 116, respectively. Data communication service 118 manages the sharing of information, such as photographs, among the people using terminal devices 106 and 110. Service 118 may be embodied in software utilizing a CPU and storage media on a single network server, such as an IBM xSeries 135 Rack mount Linux-based server (see http://www.pc.ibm.com/us/eserver/xseries/ for more information) executing MySQL, FTPS, and HTTPS server software. Alternatively, Service 118 may execute across a network of servers in which account management, session management, and content management are each controlled by one or more separate hardware devices. Further information about MySQL, FTPS and HTTPS can be found at http://www.mysgl.com/, http://www.ford-hutchinson.com/˜fh-1-pfh/ftps-ext.html, and http://wp.netscape.com/eng/ssl3/draft302.txt.

The present invention allows two or more people to share visual information over the Internet while talking in a teleconference, thus although only two communication appliances and only two terminal devices are depicted in FIG. 1, many such devices could be used in a single session.

The following illustrates a preferred means by which the present invention utilizes data from the first communication service 108 to create the appropriate data sharing connections in data communication service 118. A first communication appliance 100, such as a telephone, is communicating with a second communication appliance 104, such as a cellular phone, by means of a first communication service 108, such as a conference service. Such conference services allow two or more communication appliances to communicate with one another over a first communication network 102, such as the public switched telephone network (PSTN). Notably, in the PSTN, end-user communication appliances such as 100 and 104 are identified using a network addressing scheme, such as the North American numbering plan's telephone numbers.

The users of communication appliance 100 and 102 each dial the 10 digit telephone number of a conference service associated with first communication service 108. First communication service 108 receives signaling information through communication network 102, the signaling information containing references to the telephone numbers associated with each of connected communication appliances, e.g., the calling number identification data (CID) present in caller ID services and in SS7 call-setup messages. Further infommtion about caller ID and related SS7 services can be found at http://www.testmark.com/develop/tml_callerid_cnt.html.

As a result, first communication service 108 sends a session initiation request to data communication service 118 indicating an active call among communication appliances 100 and 104. If additional communication appliances are added to the conference, additional session update requests are sent from 108 to 118. Signals between communication services 108 and 118 are transmitted using TCP/IP, and routed through a data communication network 114, such as the Internet. Session initiation and update requests contain the caller ID associated with each of the communication appliances connected to each other through first communication service 108.

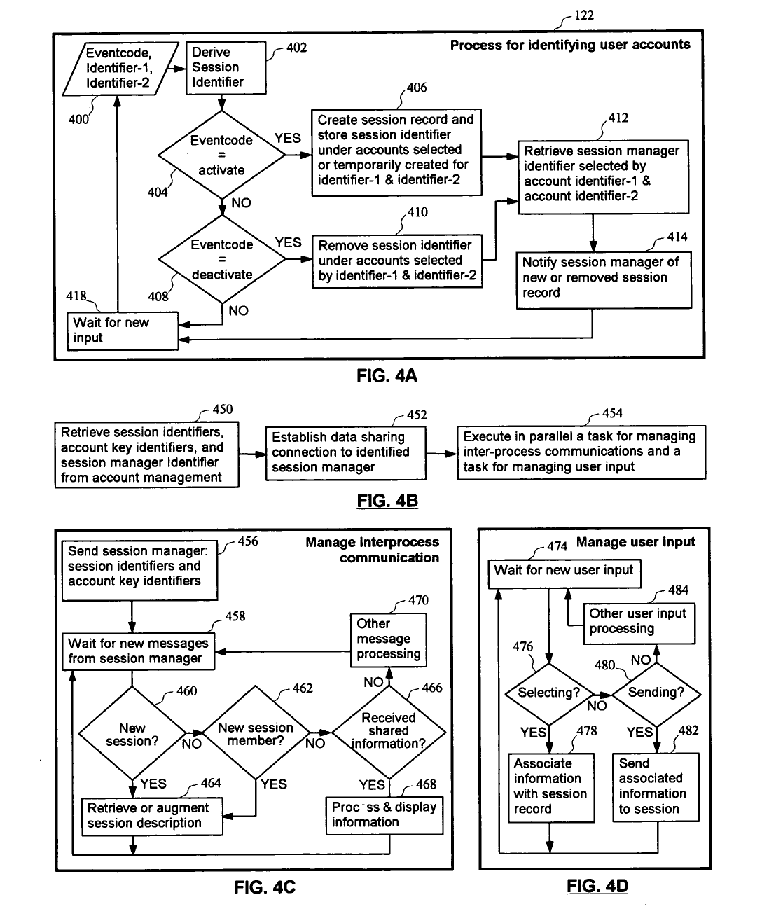

The Caller IDs contained in the session initiation and session update requests are examples of account identifiers and are used to identify associated user accounts, stored in database 124. Management of the user accounts are handled through account management means 120, which includes 122, the process for identifying user accounts, detailed below in the discussion of FIG. 4. If no user account is located, then a temporary user account is created. A session initiation request also causes session manager process 126 to create a session record containing a session identifier and a list of user identifiers, the list identifying the user accounts participating in the telephone conference. The association between the account identifier and the session identifier is also stored in database 124.

Concurrent with their telephone conference, the users of communication appliances 100 and 104 each log into data communication service 118 using terminal devices 106 and 110, respectively. Each login may occur prior or subsequent to the telephone conference, but the associations required to establish data sharing privileges on the data sharing connections 130, which allows information exchanges between terminal devices 106 and 110, is not established until after the telephone conference has been established through first communication service 108.

The login process for terminal device 106 is mediated by terminal software process 112 communicating with data communication service 118, and the login process for terminal device 110 is mediated by terminal software process 116. Data communication service 118 is comprised of account management process 120, session management process 126, account database 124, and optionally content management servers 134.

When a telephone conference is established through first communication service 108, the process for identifying user accounts 122 will result in a new session record stored for all user accounts that are specified by the first communication service 108. If needed, a temporary user account will be created for any party on the teleconference that does not have an existing account.

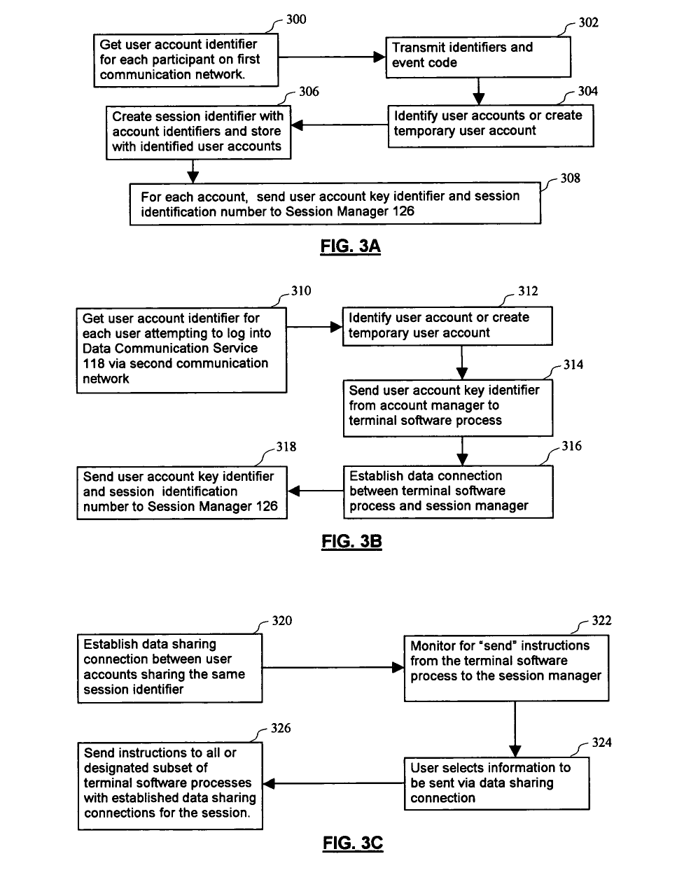

When a login request from terminal software processes 112 or 116 is invoked, account management server 120 executes the process shown in FIG. 3B, in which account identifiers and associated personal identification numbers are extracted from the request and used to locate a user account record in database 124 that contains the same account identifier(s) and personal identification number(s). If a user account is identified and a session identifier has already been associated with the user account, the session record in the session management server 126 with that session identifier will be updated to reflect the online status of the user once a data sharing connection between the terminal software process and the session management server has been established.

As part of the login procedure for each terminal software process, a data sharing connection is created for the user account on session manager 126 to enable communication between session manager 126 and the terminal software process. One exemplary type of data sharing connection is a TCP/IP socket connection. For example, if a person talking in a teleconference from communication appliance 100 logs into the data communication service 118 from nearby terminal device 106, then a data sharing connection 130A is created on session management server 126 for communication with communication appliance 106, and is associated with the user account identified in the login procedure. Further information regarding TCP/IP socket connections can be found in: “The Protocols (TCP/IP Illustrated, Volume 1)” by Richard Stevens, Addison-Wesley, first edition, (January 1994). A separate data sharing connection 130B is created when terminal software process logs into data communication service 118.

When a person using terminal device 106 decides to send visual information, the person uses an input device to select visual information from a display monitor on terminal device 106, and uses an input device to invoke a “send” operation. If the visual information is a local file or image copied from the terminal device screen, then terminal software process 112 transfers the file or image using a file transfer protocol, such as FTP, to a designated content server. The content server for a user account is communicated to the terminal software process during the login procedure. For example, when a person logs into data communication service 118 from terminal device 106, terminal software process 112 is instructed to use one of the content servers 134A through 134B. The content server may reside on the same physical hardware as session management server 126, or can reside on a different computer that is configured as a web server and is accessible through the Internet. After the file has been transferred to the designated content server, terminal software process 112 generates a URL that designates the address of the transferred file or image. Terminal software process 112 then instructs session manager 126 to inform all of the other terminal software processes (such as terminal process 116) listed in the session record that they should download the content designated by the URL.

If the content selected by the person at terminal device 106 is already associated with a URL, then terminal process 112 signals session management server 126 to instruct all of the other terminal software processes (such as terminal process 116) to retrieve the information associated with the URL.

Upon receiving instructions from session management server 126 to retrieve information from a content or web server, terminal software process 116 issues a request to retrieve the information and display or process the acquired information. Terminal software process 116 contains or controls a web browser executing a Java applet that communicates with data communication service 118. Upon receiving content retrieval instructions from session manager 126, the Java applet instructs a web browser frame or window to retrieve information from the designated URL, depending on the type of content. Alternatively, the retrieval instructions can be interpreted as instructions for the Java Applet to both retrieve the information from the designated URL, and perform its own processing or display operations.

Instead of providing a teleconference bridge, an alternative form of communication service 108 provides a call monitoring service that records the caller identification number associated with calls terminating or originating at communication appliance 100.

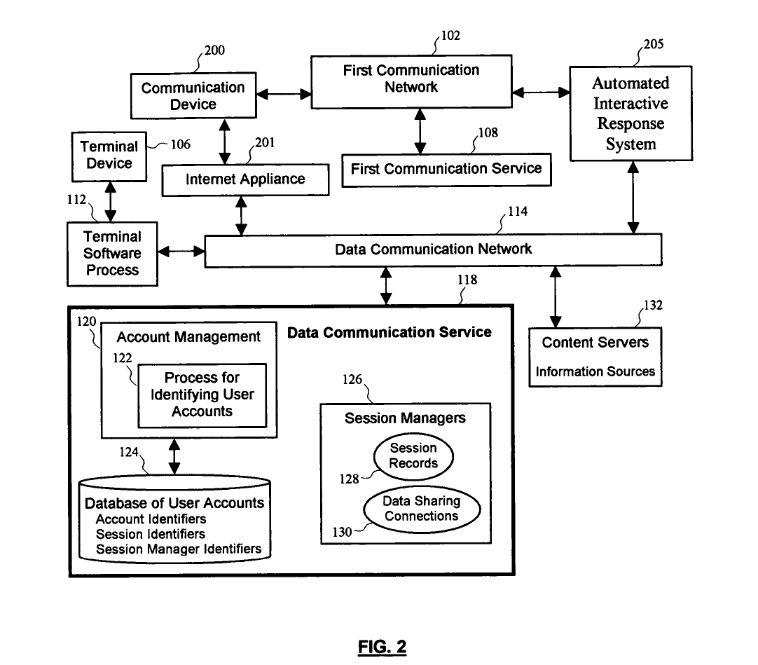

FIG. 2 contains several alternatives to the exemplary system diagrammed in FIG. 1, and is distinguished, in part, by the inclusion of Communication Appliance 200 and Internet Appliance 201 which may be housed in the same physical device and with is capable of directly connecting to Data Communication Network 114. An example of Communication Appliance 200 is an acoustic interface coupled to data networking apparatus such as an Ethernet card or 802.11b card.

An example in which these two are housed in the same physical device is an Internet phone such as a Micronet SP5100 (see http://www.micronet.info/Products/voip/SP5100.asp). An alternative example is an ordinary telephone connected to a device that is Internet accessible and which conveys caller setup data to a designated application database via the Internet, e.g., a PC connected to a Whozz Calling Caller-ID box manufactured by A&A Teledata Services, Inc. (see http://www.aateledata.com/Products/plus_overview.html).

In this exemplary embodiment of the invention, call setup information is received by Internet Appliance 201 and set from Internet Appliance 201 to Data Communication Service 118 via Data Communication Network 114, thus eliminating the need to have First Communication Service 108 convey caller identification information to Data Communication Service 118.

FIG. 2 is also distinguished by the Interactive Response System 205. Such systems are capable of interacting with humans through auditory and textual means, according to predefined sequences of logic. Common examples are voice-activated and TouchTone-activated, menu-driven, voice response systems used for reservation enquiries and orders. Examples include the Intel Dialogic D/4PCI Voice Board. Voice response systems can link telephone callers with Internet accessible data and services. Systems such as the Voxeo VoiceCenter™ IVR Platform can therefore be used to interact with a caller over First Communication Network 102 while at the same time sending visual information to the same caller over Data Communication Network 114, according to the methods of the present invention.

The methods of the present invention are described in FIGS. 3A, 3B and 3C. In step 300, account identifiers are collected for each participant in the conversation on First Communication Network 102. An example of an account identifier is the telephone number of each participant and it could be collected as part of First Communication Service 108 or by means of Internet Appliance 201. In step 302, the collected identifiers are transmitted to Data Communication Service 118 via Data Communication Network 114, along with an event code indicating that the participants are engaged in a conversation. As new participants join the discussion, their account identifiers are sent to Data Communication Service 114 using similar methods.

Turning to FIGS. 3A, 3B and 3C, the steps shown in 3A, could occur before, after, or at the same time as those in FIG. 3B. However, the steps shown in FIG. 3A and FIG. 3B must occur before those shown in FIG. 3C. The present invention allows either order: some participants can log in prior to joining the conversation and some can log in after joining the conversation.

In step 304, when the account identifiers are received by Data Communication Service 114, Account Management Process 122 identifies the user account, establishing a temporary account if no existing account is found. In step 306, a common session identifier is created for all of the participants in a single conversation. This session identifier is stored with each participant's user account in User Account Database 124. In step 308, the session identifier and account key identifier is sent to Session Manager 126. The account key identifier is a unique code sequence that identifies the account. Thus, for example, a user of the system may be identified through a telephone number via the First Communication Network and through a login and password on the Data network, both account identifiers (telephone number and login/password) identifying the same account and therefore the same account key identifier.

The participants of the conference identified in step 304 can also log into Data Communication Service 118 using a Terminal Device such as 106 or 110 via Data Communication Network 114., In step 310, Data Communication Service 118 receives a login request from a terminal software process, such as 112 or 116, which is conveyed to Account Manager 120. The account identifier identifies the user's account in step 312. If the account identifier does not identify an existing account, then a temporary user account is created. Notably, additional identifiers, such as a telephone number, are requested if no existing user account is found. The additional identifier(s) are used in an additional attempt to locate a previously established user account. For example, a temporary user account created in 304 with an identifier such as a telephone number, can be retrieved in step 312, if the login occurs after the conversation is connected on First Communication Network 102. Likewise, a temporary user account created in step 312, with a telephone number as an additional identifier, can be retrieved in step 304, if the log in occurs before the conversation is connected on First Communication Network 102.

In step 314, the user key identifier and session identifier is sent from Account Manager 120 to the terminal software process that is attempting to log into Data Communication Service 118. In step 316, a data connection is established between the terminal software process and Session Manager 126. As part of the process for establishing the data connection, in step 318, the terminal software process sends the account key identifier and session identifier to Session Manager 126.

At this point in the process, at least one participant in a First Communication Network conversation that was reported to Data Communication Service 118 is also logged into Data Communication Service 118 via Data Communication Network 114. In step 320, Session Manager 126 establishes a connection among users who share the same session identifier and who have established a data connection with the Session Manager via a terminal software process, such as 112 and 116. In step 322, the Session Manager begins monitoring the established connections for an instruction to send data to users sharing the same session identifier. To share information, a user, who has permission to send information, indicates, in step 324, the information using input apparatus such as a keyboard and mouse. The information to be sent can be any visual image displayed on the user's terminal monitor or any multimedia data accessible or created through the user's terminal and associated software (such as a web or file browser, or audio file). Having received an instruction to share data, the Session Manager instructs some or all of the terminal software processes (sharing the same session identifier) to retrieve data from a specified URL. The specified URL can designate content stored on a content server, such as Content Servers 132, 134A and 134B, or content stored on a user's terminal device. In the preferred and more secure embodiment, if the selected information resides on a user's terminal device, the information is first sent to a Content Server for temporary or permanent storage.

Turning to FIGS. 4A and 4B, FIG. 4A shows an exemplary flow chart of the process for identifying user accounts 122. When process 122 receives a telephone connection event with account identifiers in step 400, it will derive a session identifier for the call if needed in step 402, and test to see if the event is due to “activation” of a new connection in step 404 or if it is due to “deactivation” of an existing connection in step 408. If the event is “activation”, process 122 will create a new session record and store the session identifier under accounts selected or temporarily created for account identifiers in step 406. If the event is “deactivation”, process 122 will remove the session record and remove the session ID of the same record from the accounts selected by account identifiers, see step 410. Following step 406 and step 410, process 122 will retrieve the session manager identifier under identified accounts in step 412, notify identified session manager of new or removed session record in step 414, and wait for new input events in step 418.

Step 414 of process 122 allows the session manager to immediately establish the associations required for data sharing privileges and notify the terminal software process 112 through the existing data sharing connection if one has been established.

FIG. 4B is an exemplary flow chart of the terminal software process 112 and 116 for establishing connection between a user terminal ant the session manager, and coordinating communication with the session manager, user inputs, and information display. The process shows an initial login procedure in step 450, then the creation of a TCP/IP data connection to the session manager in step 452. Finally, in step 454, process 112 executes two parallel tasks, shown in FIGS. 4C and 4D. FIG. 4C shows an exemplary flow chart of a parallel task for managing the inter-process communications between process 112 and a session manager. It starts, in step 456, by sending whatever account key identifiers and session identifiers are available from the account database. Then it waits for new messages from the session manager in step 458. FIG. 4C shows specific processing for the most important messages as they relate to the invention: processing of new session messages in step 460, processing of new session members/participants in step 462, and receiving shared information in step 466. All other messages are processed by step 470. Steps 460 and 462 lead to step 464, where updates from the session manager are requested or the data in the message itself is used to augment the session description in the local memory of the terminal software process. Following the reception of a data-sharing event in step 466, step 468 will process and display the information appropriately. FIG. 4D shows an exemplary flow chart of a parallel task for managing user inputs that starts by waiting for user input in step 474. FIG. 4D shows specific processing for the most important user inputs as they relate to the invention: the selection of data to be shared in step 476 then associating it with a session record in step 478, designating a send operation in step 480 then sending the associated information in step 482. All other user input processing is handled by step 484.

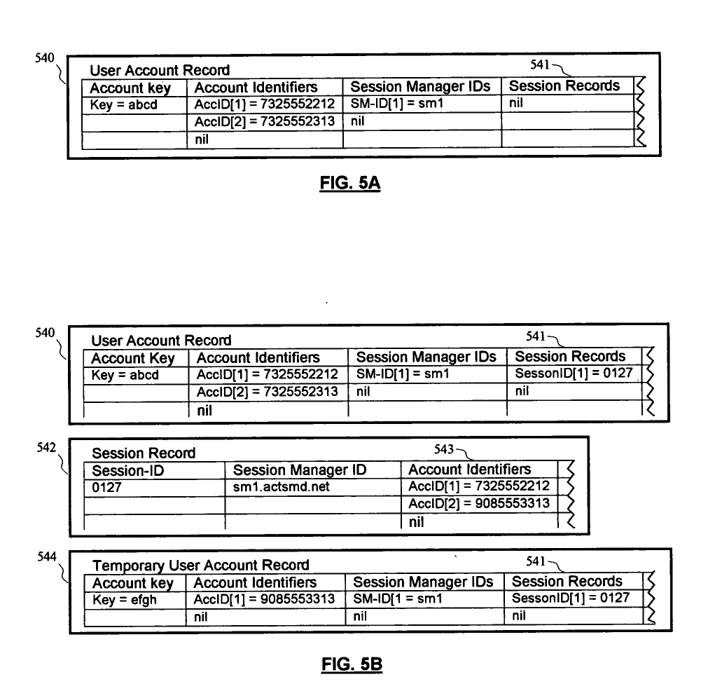

FIG. 5A shows an exemplary illustration of a user account record 540 prior to associations required for establishing data sharing privileges. FIG. 5A shows that the fields, numbered 541, for storing session records are empty. FIG. 5B shows an exemplary illustration of a user account record 540, a temporary user account record 544, a session record 542, and all associations required for establishing data sharing privileges between account records 540 and 544. The field labeled 541 in account records 540 and 544 show the association with the session record. The field labeled 543 in the session record 542 shows the associations with accounts that are members of the session.

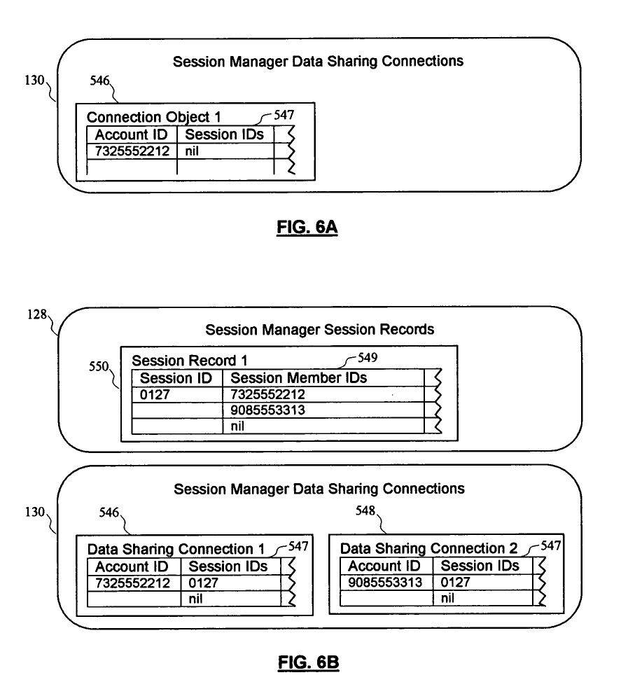

FIG. 6A shows an exemplary illustration of a session manager data sharing connection record 546 prior to associations required for establishing data sharing privileges. Data sharing connection records are data structures managed by the session management software. Connection record 546 shows all fields for session associations 547 empty. FIG. 6B shows an exemplary illustration of session manager data sharing connections 546 and 548 after associations required for data sharing privileges have been established. In FIG. 6B session record 550 is shown within a collection of session records, see 128. The field labeled 547 in the data sharing connection records 546 and 548 show the association with session record 550. The field labeled 549 in the session record 550 shows the associations with data sharing connection records 546 and 548.

The preceding embodiments of the present invention, particularly, any “preferred” embodiments, are possible examples of implementations, set forth for a clear understanding of the principles of the invention. It should be emphasized that the scope of the present invention is not limited to these embodiments. Many variations and modifications may be made to the preceding embodiment(s) of the invention without departing substantially from the spirit and principles of the invention. All such modifications and variations are included herein within the scope of the present invention as defined by the claims set forth below.

1. A method for establishing a plurality of data sharing connections in a data communication service among a plurality of users who are concurrently communicating on a first communication service, each user respectively associated with one member of a plurality of user accounts, said data communication service distinct from the first communication service, and the method comprising the steps of:
a) associating a session record with at least two user accounts, each user account identifying one member of the plurality of users communicating with one another on said first communication service, the user account selected from the group consisting of permanent and temporary user accounts,
b) identifying said session record for at least one data sharing connection between a software process acting on behalf of a terminal device on said data communication service and a session manager, the association based upon an account identifier provided through said software process and corresponding to at least one user of the terminal, thereby establishing the data sharing connection for the at least one software process,
c) associating the session record with information to be conveyed across said data communication service to the at least one terminal device,
d) sending the information over the at least one data sharing connection, each connection associated with said session record.
whereby a plurality of users will receive the information sent by at least one user over the data communication service while they remain connected to each other on the first communication service.

2. The method of claim 1 further comprising the step of specifying data sharing privileges for the at least two users of said data communication service such that the at least one of the users can send and receive information and the at least one of the other users can only receive information.

3. The method of claim 1 further comprising the step of specifying data sharing attributes for at least one user account of said data communication service such that the information is transformed in accord with said attributes.

4. The method of claim 1 further comprising the step of ending the data sharing connection for the at least one terminal on the data communication service when the user of said terminal is no longer communicating over the first communication service.

5. The method of claim 1 wherein a communication appliance used with the first communication service is distinct and independent of the terminal device used with the data communication service.

6. The method of claim 1 wherein the first communication service interconnects a plurality of networks designed for voice communication.

7. The method of claim 1 wherein the data communication service is accessed through a plurality of networks designed for data communication.

8. The method of claim 7 wherein each member of said plurality of networks is selected from the group consisting of television broadcast networks, wireless packet networks, dial-up data networks, and broadband data networks.

9. The method of claim 7 wherein the data communication service is a television narrowcast service transmitting signals for display on a television a over a digital network selected from the group consisting of a plurality of cable networks, satellite television networks, and low power wireless television networks.

10. The method of claim 9 wherein said account identifier is automatically provided through the data communication service when the television is tuned to a specific channel

11. The method of claim 1 wherein said account identifier is entered manually through said software process acting on behalf of a terminal on the data communication service before said software process communicates with the session manager.

12. The user account of claim 1 wherein said user account is identified by at least one account identifier, said account identifier formed by combining components selected from the group containing telephone numbers, email addresses, instant messaging addresses, account logins, geographic addresses, personal identification numbers, spoken utterances, handwriting, and biometric characteristics.

13. An system for sharing information on a data communication network based on a concurrent connection among a plurality of users communicating with one another on a first communication network, the data communication network distinct from the first communication network, comprising:
a) a plurality of terminal devices for retrieving multimedia information from a plurality of information sources on said data communication network,
b) account management means for determining a user account for each of at least two members of said plurality of users who are communicating with one another on the first communication network, the user account selected from a group consisting of permanent and temporary user accounts,
c) first means for associating a session identifier with the at least two user accounts, each user account identified by a user account identifier,
d) terminal software means for establishing a connection on a data communication network between at least one terminal device and a session manager, said connection providing an account identifier, thereby establishing session access for the at least one terminal device,
e) second means for selecting information to be transmitted on the data communication network, and
f) session manager means for routing the selected information over the data sharing connections to the terminal devices associated with the same session identifier, whereby information can be shared among said plurality users of a data communication network, while the users communicate on the first communication network.

14. the method of claim 13 wherein at least one user of said plurality of users is an automated interactive response system, responsive to an input signal from at least one human user communicating over the first communication network and the interactive response device sending responses to the at least one human user over the data communication network.

15. The method of claim 13 further comprising a means for specifying bandwidth and display parameters for at least one terminal device of said plurality of terminal devices so that the shared information is displayed appropriately on the at least one terminal device.

16. The method of claim 13 further comprising a means for de-activating the session identifier after each of the users of the plurality of users associated with the session identifier have terminated their respective connections on the first communication service.

17. The method of claim 16 further comprising a means of providing access to a history of the information shared, the history comprising instructions for retrieving the information shared over the data communication service.

18. The method of claim 16 further comprising means for re-activating the session identifier when at least two users of the plurality of users associated with the de-activated session identifier have re-established communication through the first communication service, each user identifying a user account that was associated with the de-activated session identifier.

19. The method of claim 13 wherein means for selecting the data to be shared is a plurality of software algorithms executing on a computer processor.

20. A method for sharing information on a data network, the method comprising the steps of:
providing information across a data connection to a plurality of recipients, in response to said recipient also participating in a voice connection, wherein each of the recipient is identified by a user account activated when establishing said voice connection and independently identified when establishing said data connection, the data connection distinct from the voice connection.
